(19) United States
(12) Patent Application Publication
(10) Pub. No.: US 2008/0177817 A1
(43) Pub. Date: Jul. 24, 2008

(54) Inversion of alternate instruction and/or data bits in a computer

(76) Inventor: Charles H. Moore, Sierra City, CA (US)

Correspondence Address: HENNEMAN & ASSOCIATES, PLC, 714 W. MICHIGAN AVE., THREE RIVERS, MI, 49093, US

(21) Appl. No.: 12/005,156

(22) Filed: Dec. 21, 2007

Related U.S. Application Data
(60) Provisional application No. 60/876,379, filed on Dec. 21, 2006.

(51) Int. Cl. G06F 7/42

(52) U.S. Cl. 708/700

(57) ABSTRACT

A basic computer circuit (30) with alternate bits inverted. Two 18-bit registers (32, 34) are connected to ALU (36) to perform ripple-carry addition, wherein 1-high number representation is implemented in the circuit portions corresponding to odd-numbered bit positions, and inverse representation, in even-numbered bit positions. Owing to alternate bit inversion, carry calculation for 1-bit addition can be performed in only one inverter latency, resulting in a fast 18-bit adder with small die area. Inverted number representation in alternate bit positions can be used in other combinatorial circuits, where an extra inverter stage is conventionally required to adjust the logic level, to reduce latency of operation and die area.

### RELATED APPLICATIONS

This application claims the benefit of co-pending U.S. Provisional Patent Application No. 60/876,379, filed on Dec. 21, 2006 by the same inventor, which is incorporated herein by reference in its entirety.

### BACKGROUND OF THE INVENTION

1. Field of the Invention

The present invention relates to the field of electrical computers that perform arithmetic processing and calculating, and more particularly to the physical representation of binary numbers in computer circuits.

2. Description of the Background Art

A digital computer operates by manipulating binary numbers (also called True and False logic states or Boolean values) as sequences of high and low values of a physical property, which is typically an electrical circuit potential (voltage). Conventionally, a high voltage value (or level) is assigned to represent binary 1 and a low value, binary 0 (herein referred to as 1-high representation), or vice versa (herein referred to as 1-low or inverted representation), uniformly throughout a computer circuit. Variation of bit representation is known in serial digital signal transmission and in memory chips (to balance the average signal level and reduce RFI), but not in computer circuits. A uniform number representation in the electrical circuits of a computer or data processor simplifies its design, testing, and writing the instructions for operating it. In the current art, entire logic families of devices employ a fixed, uniform representation. For example 1.5 Volt CMOS uses an electrical circuit potential of about 1.5 V to represent a binary 1, and a potential of about 0 V to represent binary 0.

How conventional binary number representation is related to circuit requirements and operation can be seen from an example of basic computer operation, such as multi-bit addition, which is often especially determinative of how fast a computer processor can perform a useful task. A block diagram of a two-input ripple-carry adder 10 known in the art is depicted in FIG. 1, wherein each block 12 is a combinatorial circuit representing a 1-bit full adder performing addition of one bit position of two multi-bit addend words A, B, and a carry-in value C received from the adjacent, lower-order bit position; only the four lowest-order bit positions (blocks 0, 1, 2, 3) are shown, starting with the least significant bit (LSB). In the figure, A₀, B₀, A₁, B₁, A₂, B₂, A₃, B₃ are input addend bit values and C₀, C₁, C₂, C₃ are carry-in bit values for bit positions 0, 1, 2, 3, respectively. Each block 12 computes a bit value S₀, S₁, S₂, S₃ of the sum word S, and C₄ is the carry-out value to the next higher order bit position (not shown). It can be seen that the carry-out from one block is the carry-in to the next block, and therefore the bit position sums are calculated sequentially, and latericies of carry calculations are additive, whereas the calculations that do not involve a carry value can all be performed in parallel as soon as the addend words are applied to the circuit, within a respective combinatorial circuit latency. Thus carry delay will dominate the overall latency if the number of bits (word size) is large. While several different techniques to perform multi-bit addition are known in the art, wherein parallelism (and grouping of bit positions) is employed in various ways, all are subject to latency (delay time) resulting from the sum at any bit position (or grouping of bits) depending upon all of the lower-order bit inputs, or equivalently stated, a 1-bit addition at any bit position requires a carry from the adjacent lower-order bit.

A circuit diagram of a portion 14 of an adder block 12 of adder 10 is shown in FIG. 2, depicting a known optimal CMOS combinatorial circuit that performs calculation of the carry-out value C₂ of the bit-1 block, in response to three 1-bit inputs A₁, B₁, C₁. In this circuit an inverter 16, which incurs latency, needs to be included to adjust the logic level at the output, for uniform binary number representation of carry-in and carry-out in each block. Inverting circuit portions for uniform number representation can be required in other combinatorial circuits, such as those performing multi-bit addition according to other known techniques. Clearly, it would be advantageous to find a way to provide basic circuits that do not require such inverting circuit portions for adjustment of number representation and thus have reduced latency and better computer performance in terms of higher speed of computation and signal processing, of using die area and power sparingly, and of being capable in multiprocessor arrays and embedded systems applications. However, to the inventor's knowledge, no satisfactory solution has been known prior to the present invention.

### SUMMARY

Accordingly, it is an object of the present invention to provide an apparatus and method for alternate bits inverted representation of binary numbers in computer circuits, resulting in faster performance of addition and other combinatorial operations involving multi-bit binary numbers.

It is still another object of the present invention to provide an apparatus and method for providing computer circuits with smaller area.

It is yet another object of the present invention to provide an apparatus and method for providing adder circuits that do not require inverting portions for carry calculation.

Briefly, the present invention is a method and apparatus for reducing latency in a computer by eliminating latency causing invertors. This is accomplished by allowing certain data bits to remain uninverted and compensating therefor in the associated circuitry.

These and other objects and advantages of the present invention will become clear to those skilled in the art in view of the description of modes of carrying out the invention, and the industrial applicability thereof, as described herein and as illustrated in the several figures of the drawing. The objects and advantages listed are not an exhaustive list of all possible advantages of the invention. Moreover, it will be possible to practice the invention even where one or more of the intended objects and/or advantages might be absent or not required in the application.

Further, those skilled in the art will recognize that various embodiments of the present invention may achieve one or more, but not necessarily all, of the described objects and/or advantages. Accordingly, the objects and/or advantages described herein are not essential elements of the present invention, and should not be construed as limitations.

### BRIEF DESCRIPTION OF THE DRAWINGS

In the accompanying drawings:

FIG. 1 (PRIOR ART) is a symbolic block diagram of a conventional ripple-carry adder using uniform binary number representation;

FIG. 2 (PRIOR ART) is a circuit diagram showing the carry calculation portions of a 1-bit adder block in greater detail, with conventional uniform binary number representation;

FIG. 3 is a symbolic block diagram of a ripple-carry adder using non-uniform binary number representation, wherein alternate bits are inverted according to an embodiment of the invention;

FIG. 4 is a circuit diagram of a fast carry calculation portion of a 1-bit adder block, using alternate bit inversion according to the invention;

FIG. 5 compares addition of 5-bit binary numbers in the conventional manner and with alternate bits inverted;

FIG. 6 is a block diagram of a basic computer circuit including two 18-bit registers connected to an arithmetic logic unit, wherein alternate bits are inverted according to the invention;

FIG. 7 is a circuit diagram of two adjacent register cells of the basic computer circuit of FIG. 6, employing alternate bit inversion according to the invention; and

FIG. 8 is a circuit diagram of a fast carry calculation circuit adapted to operate in the computer circuit of FIG. 6, employing alternate bit inversion, according to an alternate embodiment of the invention.

### DETAILED DESCRIPTION OF THE INVENTION

This invention is described in the following description with reference to the figures, in which like numbers represent the same or similar elements. While this invention is described in terms of modes for achieving this invention's objectives, it will be appreciated by those skilled in the art that variations may be accomplished in view of these teachings without deviating from the spirit or scope of the present invention.

The embodiments and variations of the invention described herein, and/or shown in the drawings, are presented by way of example only and are not limiting as to the scope of the invention. Unless otherwise specifically stated, individual aspects and components of the invention may be omitted or modified, or may have substituted therefore known equivalents, or as yet unknown substitutes such as may be developed in the future or such as may be found to be acceptable substitutes in the future. The invention may also be modified for a variety of applications while remaining within the spirit and scope of the claimed invention, since the range of potential applications is great, and since it is intended that the present invention be adaptable to many such variations.

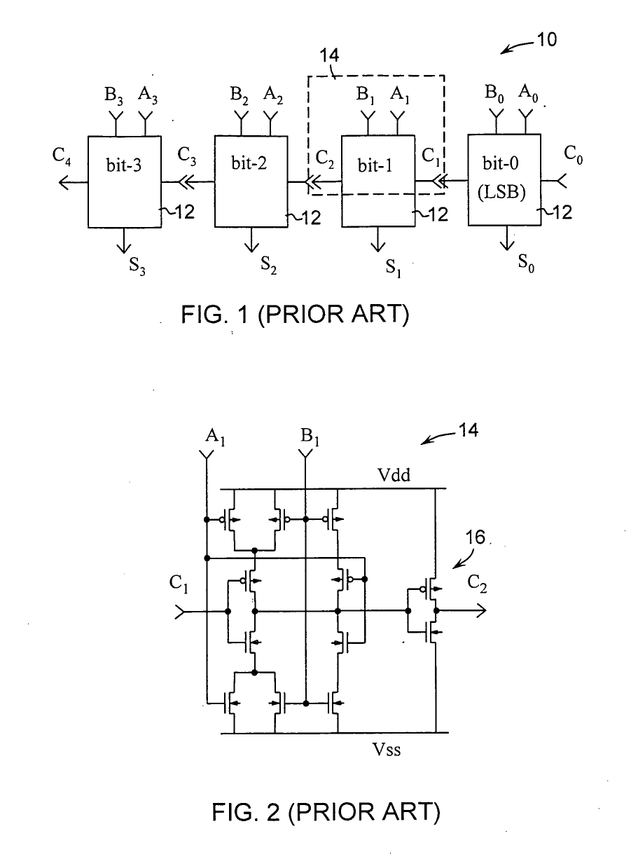

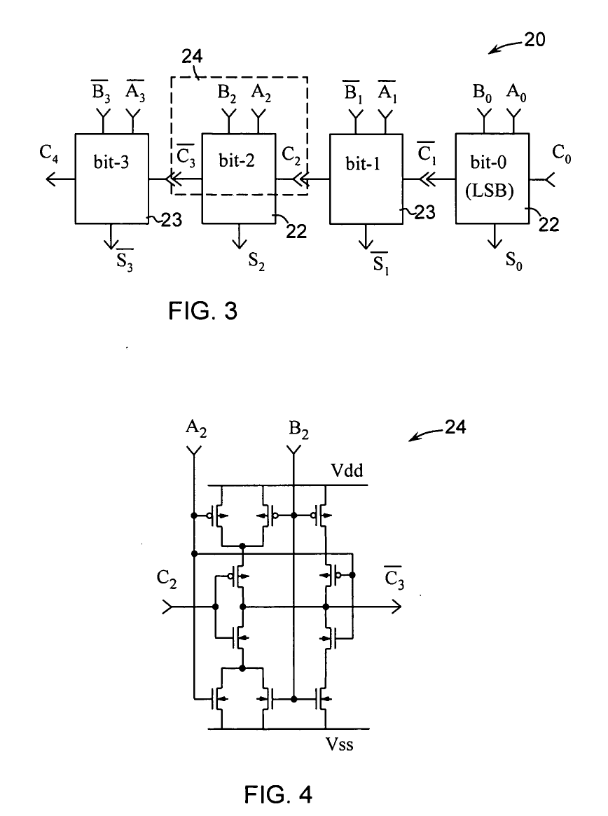

A known mode for carrying out the invention is a basic computer circuit, for example, a multi-bit two-input ripple-carry adder with alternate bits inverted. The inventive computer circuit is depicted in a block diagram view in FIG. 3 and is designated therein by the general reference character 20. The adder 20 has binary number representation inverted in alternate (odd-numbered and even-numbered) bit positions, according to an embodiment of the invention. The present invention recognizes that the conventional practice and assumption, that binary number representation should be uniform throughout a digital circuit, is basically unwarranted and important advantage can be gained by departing from this practice and using alternating representation. Inverted binary number (logic) values are indicated in the figures by A̅₁̅, B̅₁̅, A̅₃̅, B̅₃̅, C̅₁̅, C̅₃̅, S̅₁̅, S̅₃̅, according to conventional complement notation. In particular, a 1-high representation can be used in even-numbered blocks 22 (for bit positions 0, 2, 4, . . . ), and an inverted (1-low) representation can be used in odd-numbered blocks 23 (for bit positions 1, 3, . . . ) in this embodiment; and in other respects, adder 20 can be substantially similar to the conventional adder 10 described hereinabove with reference to FIG. 1. A circuit diagram of the carry calculation portion 24 of the bit-2 block of adder 30 is shown in FIG. 4, using an optimal CMOS circuit implementation comprising p- and n-channel MOS transistors connected between a high voltage (Vdd) and a low voltage (Vss). As bit-2 is an even-numbered bit position, its number representation is 1-high, matching that of the prior art example described herein above with reference to FIG. 2. It can be observed by comparing the circuits, however, that circuit 24 in FIG. 4 has one less inverter stage, as the circuit without an inverter at the output provides a carry-out that is inverted with respect to the input, and this is appropriate for carry propagation at all bit positions as indicated in FIG. 3. For bit-2, carry-in is C₂ and carry-out is C̅₃̅. As number representation is inverted in odd-numbered bit positions, the input addend values for bit-3 are A̅₃̅, B̅₃̅, the carry-in is C̅₃̅ (which are the complements of A₃, B₃, and C₃), and carry-out is C₄. It is apparent that inversion of number representation in alternate bits of addend words A, B according to an embodiment of the invention, can remove the requirement of an inverter stage and its associated latency of operation in the carry calculation circuit portion, for all bit positions, and thereby can improve the speed of multi-bit ripple-carry addition significantly, in some cases up to a factor of 2.

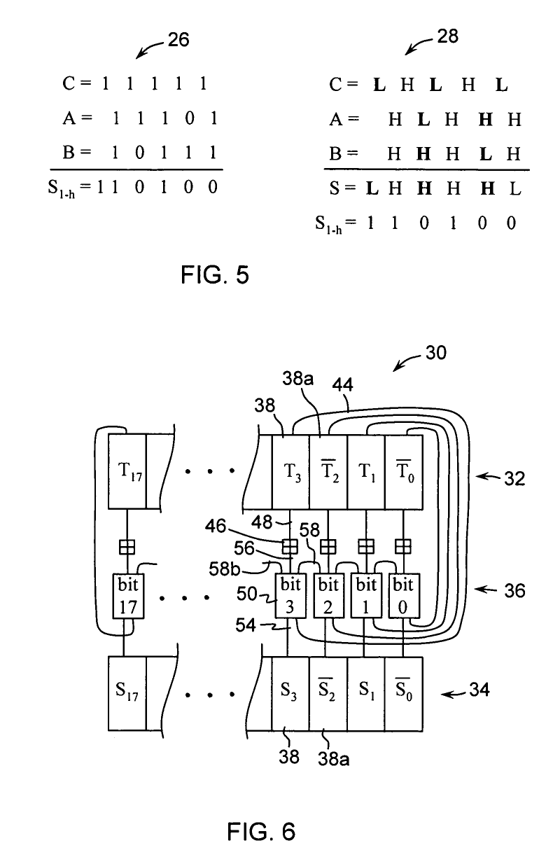

It will be apparent to those familiar with the art that the functionality of computer circuit 20 in performing a logical or arithmetic operation, for example addition, is unaffected by the choice of binary number representation. This can be illustrated, as depicted in FIG. 5, by comparing the addition of two example 5 bit binary numbers, A=11101 and B=10111, to yield a 5-bit (or 6-bit) sum S, performed using conventional and alternate-bits-inverted circuits. The comparison will show what happens at the physical circuit potential level at the 1-bit adder blocks. In FIG. 5 the characters 1, 0 denote bit values for a binary number, and the characters H, L denote “high” and “low” values of a circuit property, such as potential, which is used to represent the bit values. It will be assumed for this example that the conventional, fixed representation is 1-high, and that 1-high is also used in the circuit portions corresponding to even-numbered bit positions. It should be noted that in a circuit where the number representation is uniform and fixed to be 1-high for all bit positions, the bit values 1, 0 will correspond to circuit potentials H, L, respectively, everywhere, and thus the symbol 1 can be used in place of H, and 0 in place of L. Thus with uniform number representation as in FIG. 1, the addition proceeds as shown in addition 26 of FIG. 5; wherein the subscript 1-h for the sum S₁₋ₕ is used to emphasize that 1-high representation is employed in this example. With alternate bits inverted, according to the invention (as in FIG. 3), the addition proceeds as shown in addition 28 of FIG. 5. In this case, the circuit portion corresponding to even-numbered bit positions (in the sequence of consecutive bit positions of a multi-bit binary number) has 1-high representation; and a second circuit portion corresponding to odd-numbered bit positions has inverted, that is, 1-low representation. The bits with inverted circuit representation are shown in bold print in FIG. 5. When the H and L values of the sum S of addition 28 are converted to a uniform 1-high representation, as shown by S₁₋ₕ immediately below S in the figure, the sum can be seen to be identical to the sum of addition 26. It will be apparent to those familiar with the art that a similar conclusion will be reached when comparing circuit operation for conventional and alternate bits inverted cases, if 1-low representation is employed for the fixed representation, or if the inverted circuit portion corresponds to even-numbered bit positions. It will be further apparent that within a given bit position, regardless of one or the other number representation, 1-bit addition proceeds normally for a given set of input values, and the addends and sum are either the bit values or the complements of the bit values of the respective binary numbers, except for the carry. With alternate bits inverted according to the invention, the complement (i.e., the inverted value) of the normally calculated carry output is required as carry input to each successive bit position, as indicated by alternating straight and complemented carry value symbols in FIG. 3, and by alternating bold and not-bold print bit value symbols in FIG. 5.

The circuit of FIG. 2 can be recognized as a transistor level CMOS implementation of a particular combinatorial logic function of input values, where an extra inverter stage is required for uniform number representation, which can be eliminated by using inverted number representation in alternate bit positions as in the circuit of FIG. 3, thereby reducing latency of operation and die area required in circuit layout. Such inverter stages are known to be required also in other combinatorial logic circuits in computers and signal processors using uniform number representation, and it will be apparent to those familiar with the art that such stages can be expected to be removable in some cases in a like manner, by using inverted number representation in alternate bit positions of computer words, according to this invention, thus speeding up computer operation and reducing die area.

An example of alternate bit inversion in another basic computer circuit will be described with reference to FIGS. 6-8. A computer circuit 30, including two 18-bit registers 32, 34 connected to an arithmetic logic unit (ALU) 36, is shown in FIG. 6. Binary number representation is inverted in alternate bit positions in all elements of circuit 30; 1-high number representation can be used for odd-numbered bit positions, and inverse representation, for even-numbered bit positions, as indicated in the figure by the complement notation of the bit values.

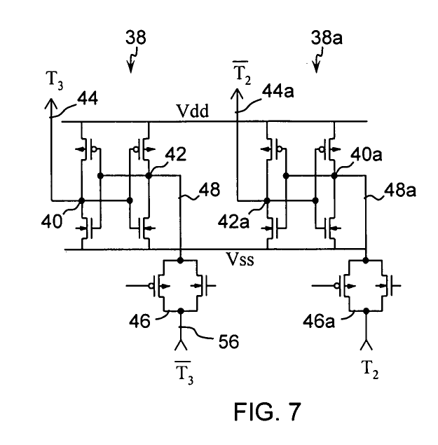

Registers 32, 34, herein called T-register and S-register, each include 18 storage cells 38, that can be for example CMOS static memory (bit) cells, as shown in FIG. 7, which depicts storage cell 38, and adjacent storage cell 38a, disposed at bit positions 3, and 2 respectively, of T-register 32. Each cell 38 comprises two cross-coupled MOS inverters connected between a high voltage (Vdd) and a low voltage (Vss), and has two stable states defined by high and low potentials at two complementary inverter nodes 40, 42, being thus adapted to store a 1-bit binary number, as known in the art. One node, for example node 40, can be designated 1-high for all bit cells, and the other node 42 will consequently hold the complementary value. It should be noted that a bit cell 38 can be single ended, employing one (read) line 44 for reading its state from one of its nodes, and another (write) line 48 connected to the complementary node for writing to the cell through write pass gate 46. Accordingly in this embodiment, read line 44 can be connected to node 40 in odd-numbered bit cells, and to node 42 in even-numbered bit cells, to implement inversion of binary number representation in alternate bit positions of the registers. As shown in FIG. 7, for even-numbered bit-2 cell 38a, the read line 44a connects to node 42a, and pass gate 46a and write line 48a connect to node 40a; thus T₂ will be read from the cell and T₂ will be written to the cell; while T₃ will be read from odd-numbered bit-3 cell, and T₃ written to it. The circuit shown in FIG. 7 can be implemented in the same manner described herein above also in the S-register 34.

ALU 36 comprises 18 1-bit arithmetic logic units (ALU's) 50, each connected to respective bit cells of the registers according to bit position, as shown in the figure. It should be understood that other connections of the ALU and T- and S-registers to other parts of the computer, for example to memory, control sequencers, input/output ports, other registers, and power supply, for purposes such as control, transmission of data and instructions, and operating power, are omitted from the figures in the interest of clarity. The circuit 30 is adapted, for example, to add a 18-bit number in the S-register to a 18-bit number in the T-register and to put the sum in the T-register, according to the ripple-carry technique. For this purpose, read lines 54 of the bit cells of the S-register 34 connect to one addend input of the corresponding 1-bit ALU's 50, and read lines 44 of the T-register connect to a second addend input, as shown in FIG. 6; the sum output lines 56 of the ALU's connect through pass gates 46 to write lines 48 of the T-register; and the carry lines 58 connect the ALU's in series. In this circuit, the carry value propagates from bit-0 position to bit-17 position during performance of each 18-bit addition, and thus the latency of addition includes the sum of 18 carry calculation latencies. However, owing to alternate bit inversion, carry calculation for 1-bit addition can be performed in only one inverter latency, for example by employing the circuit 24 of FIG. 4 described hereinabove for the carry calculation portion of ALU 50. It will be apparent to those familiar with the art that circuit 24 can make the carry outputs from successive bit positions alternate between the carry value and the complement of the carry value in the same manner as the addend bit values applied to the ALU from T- and S-registers alternate, as indicated in FIG. 6. This results in a fast 18-bit adder with a small die area provided by a ripple-carry design.

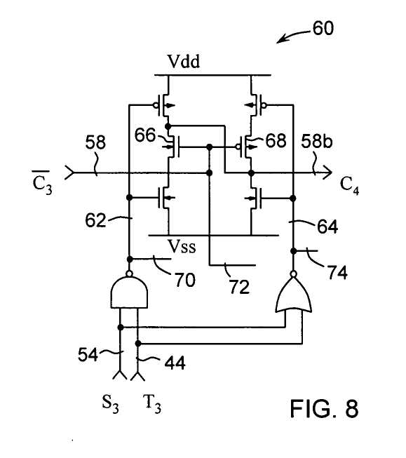

In an alternate embodiment, another circuit 60 shown in FIG. 8 can be employed for the carry calculation portion of ALU 50, to perform carry calculation in about one inverter latency. The connections for bit 3 in particular are identified in the figure, wherein C₃ is the carry input on line 58, C₄ is the carry output on line 58b connecting to the carry input of the bit-4 ALU, and T₃, S₃ are the two addend inputs to the (bit 3) ALU, on lines 44, 54 respectively. The circuit 30 (FIG. 6) can be adapted to operate asynchronously, and thus the combinatorial values on lines 62, 64 become available in circuit 60 within a NAND gate latency and a NOR gate latency after the addend values are applied to the ALU); this can happen in all bit positions in parallel, substantially at the same time. In operation of the circuit 60, carry output C₄ becomes available after the arrival time of carry input C₃ plus the gate delay of MOS transistor 66 or 68 and associated wire delay, which is substantially equivalent to one inverter latency as known in the art. In the embodiment shown in FIG. 6, the addend inputs remain connected to the register read lines and new addend values become available as soon as the register bit cells settle to a new state, in response to a new set of bit values written to the registers, by enabling appropriate write pass gates (write pass gate 46, for the T-register). In other embodiments there can be further sets of pass gates, not shown in FIGS. 6-7, to select ALU operations other than 18-bit addition. Lines 70, 72, 74 in FIG. 8 indicate internal connections to the sum computation portion of the ALU, which is not shown.

Various modifications may be made to the invention without altering its value or scope. For example, while this invention has been described herein in terms of a ripple-carry adder 20 and basic computer circuit 30, it can be employed in other basic computer circuits wherein inverter stages are conventionally used for adjustment of number representation, with equal effect.

While specific examples of the inventive alternate bits inverted binary number representation in computer circuits have been discussed herein, it is expected that there will be a great many applications for these which have not yet been envisioned. Indeed, it is one of the advantages of the present invention that the inventive method and apparatus may be adapted to a great variety of uses.

All of the above are only some of the examples of available embodiments of the present invention. Those skilled in the art will readily observe that numerous other modifications and alterations may be made without departing from the spirit and scope of the invention. Accordingly, the disclosure herein is not intended as limiting and the appended claims are to be interpreted as encompassing the entire scope of the invention.

### INDUSTRIAL APPLICABILITY

The inventive alternate bits inverted binary number representation in basic computer circuits is intended to be widely used in a great variety of applications. It is expected that it will be particularly useful in combinatorial circuit applications wherein speed, compact circuit area and lower power use are important considerations.

As discussed previously herein, the applicability of the present invention is expected to be quite general as it pertains to computer circuits at a basic level. Since the present invention may be readily produced and integrated with existing technology of computer circuits, and the like, and since the advantages as described herein are provided, it is expected that it will be readily accepted in the industry. For these and other reasons, it is expected that the utility and industrial applicability of the invention will be both significant in scope and long-lasting in duration.

NOTICE: This correspondence chart is provided for informational purposes only. It is not a part of the official patent application.

### CORRESPONDENCE CHART

10 prior-art ripple-carry adder
12 1-bit full adder block
14 prior-art carry calculation circuit
16 inverter
20 basic computer circuit (ripple-carry adder) with alternate bits inverted
22 even-numbered bit position adder block
23 odd-numbered bit position adder block
24 carry calculation circuit with inverted carry in and out
26 conventional addition (with uniform 1-high binary number representation)
28 addition with alternate bits inverted
30 basic 18-bit computer circuit
32 T-register
34 S-register
36 ALU
38, 38a storage cell of register
40, 40a inverter node of storage cell
42, 42a complementary inverter node of storage cell
44, 44a read line (of T-register bit cell)
46, 46a write pass gate
48, 48a write line
50 1-bit arithmetic logic unit
54 read line (of S-register bit cell)
56 sum output line
58, 58b carry line

I claim:

1. A digital logic circuit for processing multi-bit binary numbers having a plurality of bit positions;
wherein two distinct values of a physical property represent the bit values of a binary number; and
wherein, in even-numbered bit positions, a first of said distinct values represents binary 1 and a second of said distinct values represents binary 0; and
in odd-numbered bit positions, the first of said values represents binary 0 and the second of said values represents binary 1.

2. The digital logic circuit of claim 1, wherein:
a first plurality of portions of the digital logic circuit correspond to the even-numbered bit positions; and
a second plurality of portions of the digital logic circuit correspond to the odd-numbered bit positions.

3. The digital logic circuit of claim 1, wherein said physical property is an electrical potential.

4. The circuit of claim 3, wherein said first value is a high potential and said second value is a low potential.

5. The circuit of claim 3, wherein said first value is a low potential and said second value is a high potential.

6. The digital logic circuit of claim 1, wherein said digital logic circuit is a ripple-carry adder of multi-bit binary numbers.

7. The ripple-carry adder of claim 6, wherein said multi-bit binary numbers are 18-bit binary numbers.

8. The digital logic circuit of claim 1, wherein said digital logic circuit comprises two multi-bit registers and a multi-bit arithmetic logic unit operatively interconnected to perform ripple-carry addition of two numbers disposed in said registers and to put the sum in one of said registers.

9. The circuit of claim 1, wherein said digital logic circuit is an asynchronous logic circuit.

10. The circuit of claim 8, wherein said multi-bit arithmetic logic unit is an 18-bit airithmetic logic unit.

11. A method for manipulating multi-bit binary numbers in a digital logic circuit;
wherein said numbers have a plurality of bit positions; and
wherein two distinct values of a physical property of said digital logic circuit represent the bit values of a binary number; and
wherein, for even-numbered bit positions, a first of said distinct values represents binary 1 and a second of said distinct values represents binary 0; and for odd-numbered bit positions, the first of said values represents binary 0 and the second of said values represents binary 1.

12. The method of claim 11, wherein:
a first plurality of portions of the digital logic circuit correspond to the even-numbered bit positions; and
a second plurality of portions of the digital logic circuit correspond to the odd-numbered bit positions.

13. The method of claim 11, wherein said physical property is an electrical potential.

14. The method of claim 13, wherein said first value is a high potential and said second value is a low potential.

15. The method of claim 13, wherein said first value is a low potential and said second value is a high potential.
